(19) United States
(12) Patent Application Publication
(10) Pub. No.: US 2020/0255143 A1
(43) Pub. Date: Aug. 13, 2020

(54) THREE-DIMENSIONAL RECONSTRUCTION METHOD, SYSTEM AND APPARATUS BASED ON AERIAL PHOTOGRAPHY BY UNMANNED AERIAL VEHICLE

(71) Applicant: SZ DJI TECHNOLOGY CO., LTD., Shenzhen (CN)

(72) Inventors: Jiabin LIANG, Shenzhen (CN); Kaiyong ZHAO, Shenzhen (CN); Yuewen MA, Shenzhen (CN); Dongdong MA, Shenzhen (CN)

(21) Appl. No.: 16/863,158

(22) Filed: Apr. 30, 2020

Related U.S. Application Data
(63) Continuation of application No. PCT/CN2017/109743, filed on Nov. 7, 2017.

(51) Int. Cl. B64C 39/02; G06T 17/05; H04N 5/232; H04N 7/18; H04N 5/76

(52) U.S. Cl. CPC B64C 39/024; G06T 17/05; H04N 5/23206; H04N 7/183; B64C 2201/141; G06T 2207/10032; G06T 2200/24; G06T 2200/08; B64C 2201/027; H04N 5/76

(57) ABSTRACT

A three-dimensional (3D) reconstruction system based on aerial photography includes an unmanned aerial vehicle (UAV), a ground station, and a cloud server. The ground station is configured to determine an aerial photography parameter for indicating an aerial photography state of the UAV based on a user operation and transmit the aerial photography parameter to the UAV. The UAV is configured to receive the aerial photography parameter transmitted by the ground station; fly based on the aerial photography parameter and control an imaging device carried by the UAV to acquire aerial images during a flight; and transmit the aerial images to the cloud server. The cloud server is configured to receive the aerial images and generate a 3D model of a target area based on the aerial images.

### CROSS-REFERENCE TO RELATED APPLICATION

This application is a continuation of International Application No. PCT/CN2017/109743, filed on Nov. 7, 2017, the entire content of which is incorporated herein by reference.

### TECHNICAL FIELD

The present disclosure relates to the field of unmanned aerial vehicle (UAV) technology and, more specifically, to a three-dimensional (3D) reconstruction method, system and apparatus based on aerial photography by a UAV.

### BACKGROUND

In conventional technology, satellites in space can be used to detect electromagnetic waves reflected by objects on the surface of the earth and electromagnetic waves emitted by the objects, and physical information of the earth's surface can be extracted. Signals of the electromagnetic waves can be converted, and the resulting image is a satellite map. However, it can be difficult for users to acquire elevation information, feature heights, degrees of slopes, etc. based on the satellite map. As such, the application of the satellite maps can be very limited. In view of the foregoing, methods for establishing a 3D model of a mapping area are used such that the topography of the mapping area can be more clearly understand by using the 3D model.

In one technical solution, the 3D model of the mapping area can be manually generated by a point-by-point measurement. However, this method is labor-intensive, has several limitations, and a limited sampling density, which can affect the accuracy of the three-dimensional model. In another technical solution, a 3D reconstruction software can be used to generate the 3D model of the mapping area using aerial images. However, the process of generating a 3D model involves a large amount of calculations. As such, the 3D reconstruction software needs to be installed on a large computer. Further, the process of generating a 3D model takes a long time. Therefore, acquiring the 3D model of the mapping area by using a 3D reconstruction software is not portable and cannot be done in real-time.

### SUMMARY

In accordance with the disclosure, there is provided a three-dimensional (3D) reconstruction system based on aerial photography. The system includes an unmanned aerial vehicle (UAV), a ground station, and a cloud server. The ground station is configured to determine an aerial photography parameter for indicating an aerial photography state of the UAV based on a user operation and transmit the aerial photography parameter to the UAV. The UAV is configured to receive the aerial photography parameter transmitted by the ground station; fly based on the aerial photography parameter and control an imaging device carried by the UAV to acquire aerial images during a flight; and transmit the aerial images to the cloud server. The cloud server is configured to receive the aerial images and generate a 3D model of a target area based on the aerial images.

Also in accordance with the disclosure, there is provided a 3D reconstruction method based on aerial photography by a UAV. The method is applied to a ground station and includes: determining an aerial photography parameter for indicating an aerial photography state of the UAV based on a user operation; and transmitting the aerial photography parameter to the UAV for the UAV to acquire aerial images of a target area based on the aerial photography parameter. The aerial images is used by a cloud server to generate a 3D model of the target area. The method also includes receiving the 3D model of the target area transmitted by the cloud server.

Also in accordance with the disclosure, there is provided 3D reconstruction method based on aerial photography by a UAV. The method is applied to the UAV and includes: receiving an aerial photography parameter transmitted by a ground station for indicating an aerial photography state of the UAV; flying based on the aerial photography parameter and controlling an imaging device carried by the UAV to acquire aerial images during a flight; and transmitting the aerial images to a cloud server for the cloud server to generate a 3D model of a target area based on the aerial images.

### BRIEF DESCRIPTION OF THE DRAWINGS

FIG. 1 is a diagram of a 3D reconstruction system based on aerial photography of a UAV according to an embodiment of the present disclosure.

FIG. 2 is a flowchart of a 3D reconstruction method based on aerial photography of a UAV according to an embodiment of the present disclosure.

FIG. 3 is an example of a target area.

FIG. 4 is a flowchart of the 3D reconstruction method based on aerial photography of a UAV according to another embodiment of the present disclosure.

FIG. 5 is a flowchart of the 3D reconstruction method based on aerial photography of a UAV according to yet another embodiment of the present disclosure.

FIG. 6 is block diagram of a ground station according to an embodiment of the present disclosure.

FIG. 7 is a block diagram of a UAV according to an embodiment of the present disclosure.

FIG. 8 is a block diagram of a cloud server according to an embodiment of the present disclosure.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

Satellite maps are available in most parts of the word, and it is difficult for users to obtain 3D information, such as elevation information, feature heights, slopes, sizes, etc. from the satellite maps. As such, the application of the satellite maps is limited. Further, satellite maps also have several limitation in applications such as urban planning and disaster relief. As such, a method of establishing a 3D model of a specific target was proposed.

In one technical solution of the conventional technology, a point-by-point measurement of the specific area can be manually performed to generate a 3D model of the specific area. However, this method is labor-intensive and sampling density is limited, which can affect the accuracy of the mapped three-dimensional model. In another technical solution of the conventional technology, a 3D reconstruction software can be used to generate the 3D model of the specific area using aerial images. However, the process of generating a 3D model involves a large amount of calculations. As such, the 3D reconstruction software needs to be installed on a large computer. Further, the process of generating a 3D model takes a long time. Therefore, this method is not suitable for application scenarios, such as field surveying, which means this method is not portable and cannot be done in real-time.

In view of the foregoing, the present disclosure provides a 3D reconstruction method, system and apparatus based on aerial photography of a UAV. The system may include a ground station, s UAV, and a cloud server. The UAV may be used to perform aerial photography of a specific area to acquire aerial images, and the aerial images can be used by the cloud server to perform 3D reconstruction to generate a 3D model of the specific area. The ground station can flexibly download the generated 3D model from the cloud server. As such, in the 3D reconstruction system based on aerial photography provided in the present disclosure, the complex and high-performance computing can be realized in the cloud server, such that the ground station does not need to add and maintain expensive hardware. Further, he ground station can flexibly acquire the generated 3D model from the cloud server, which provides an improved portability and real-time performance.

The present disclosure is described in detail below with reference to the following embodiments.

The following embodiment describes the 3D reconstruction system based on aerial photography of a UAV provided in the present disclosure.

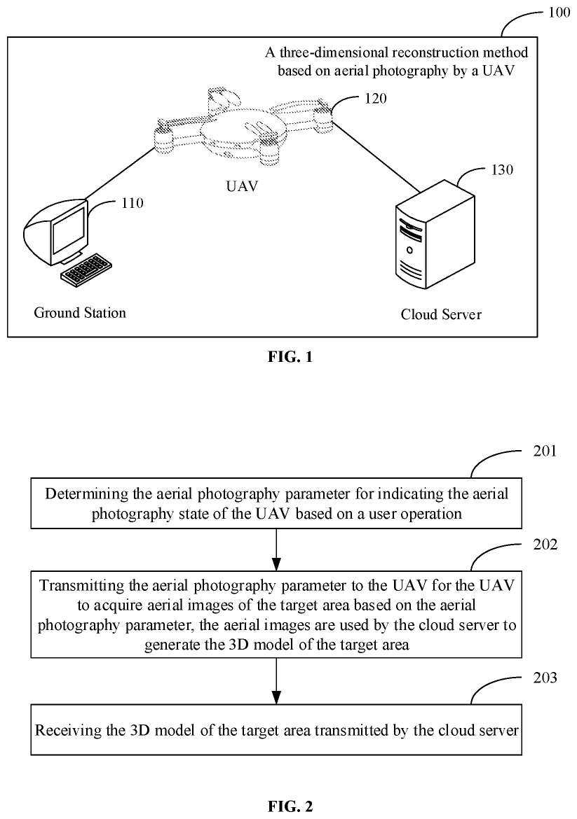

Referring to FIG. 1, which is a diagram of a 3D reconstruction system based on aerial photography of a UAV according to an embodiment of the present disclosure.

As shown in FIG. 1, an example 3D reconstruction system 100 includes a ground station 110, a UAV 120, and a cloud server 130. The ground station 110 is shown as a computer as an example. In actual applications, the ground station 110 may be a smart device, such as a smartphone or a PDA, which is not limited in the present disclosure. An imaging device (not shown in FIG. 1), such as a camera, can be carried by the UAV 120. In addition, those skilled in the art can understand that the cloud server 130 may refer to a plurality of physical servers. Among the plurality of physical servers, one of the servers can be used as a main server for resource allocation. The cloud server 130 can be highly distributed and highly virtualized.

More specifically, the ground station 110 may be configured to determine an aerial photography parameter for indicating the aerial photography state of the UAV based on a user operation, and transmit the aerial photography parameter to the UAV 120.

The UAV 120 may be configured to receive the aerial photography parameter transmitted by the ground station 110; fly based on the aerial photography parameter and control the imaging device carried by the UAV to acquire aerial images during the flight; and transmit the aerial images to the cloud server 130.

The cloud server 130 may be configured to receiver the aerial images; and generate a 3D model of a target area based on the aerial images.

It can be seen from the embodiment described above, the user can control the UAV to take aerial images of a target area by setting the aerial photography parameter through the ground station, acquire the aerial images, and the cloud server can use the aerial images to generate a 3D model of the target area. As such, the user does not need to have professional UAV operating skills, and the implementation process is simple. Further, by using the cloud server to realize the complicated 3D reconstruction process, the ground station does not need to add and maintain expensive hardware, thereby allowing the user to perform operations in various scenarios.

The following embodiments describe the 3D reconstruction method based on aerial photography of a UAV provided in the present disclosure from the perspectives of a ground station, a UAV, and a cloud server, respectively.

FIG. 2 is a flowchart of a 3D reconstruction method based on aerial photography of a UAV according to an embodiment of the present disclosure. On the basis of the system shown in FIG. 1, the method may be applied to the ground station 110 shown in FIG. 1. The method is described in detail below.

201, determining the aerial photography parameter for indicating the aerial photography state of the UAV based on a user operation.

In some embodiments, the ground station can show a satellite map to the user through a display interface, and the user can perform an operation to the satellite map on the display interface. For example, the user may manually box an area on the display interface, the boxed area may be an area to perform the 3D mapping. For the convenience of description, the area is referred to as a target area in the embodiments of the present disclosure.

It should be noted that the area manually boxed by the user can be a regular shape or an irregular shape, which is not limited in the present disclosure.

In some embodiments, the user can also specify a desired map resolution through the display interface.

In some embodiments, the ground station can automatically determine the aerial photography parameter for indicating the aerial photography state of the UAV based on the target area and the map resolution described above. The aerial photography parameter may include one or more of a flight route, a flight attitude, a flight speed, an imaging distance interval, or an imaging time interval.

In some embodiments, the flight route may be determined by using the following process.

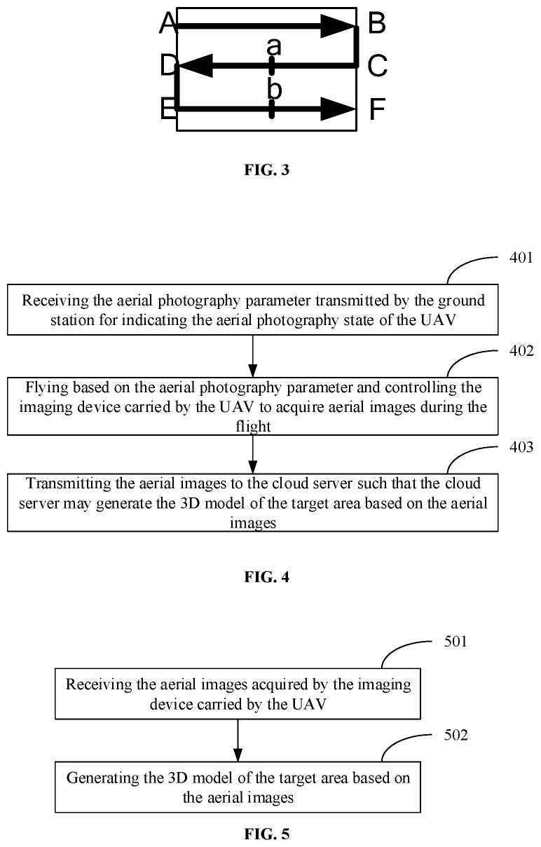

For example, as shown in FIG. 3, which is an example of the target area. The target area shown in FIG. 3 is a regular rectangular, and a position is set on a short side of the rectangular area as the starting point of the flight route, for example, point A in FIG. 3. Subsequently, a line parallel to a longer side of the rectangular area is drawn from point A to the opposite side. The intersection point of this line and the opposite side of the rectangular is point B, and a line segment AB may be a part of the flight route. Using the same method, a line segment DC and a line segment EF parallel to the longer side may be drawn as shown in FIG. 3. As such, an automatically planned flight route may be A-B-C-D-E-F. In some embodiments, every two adjacent line segments, such as the distance between line segment AB and line segment DC may be determined by the aerial survey requirements. More specifically, the overlapping rate of the aerial images acquired at the same horizontal position may be required to be greater than 70%. For example, the overlapping rate between the aerial image acquired at point A and the aerial image acquired at point B may be greater than 70%.

In some embodiments, the flight height may be determined based on the map resolution.

In some embodiments, the flight speed may be determined based on the flight route and the flight parameter of the UAV.

In some embodiments, the imaging distance interval (e.g., capturing an image at every meter that the UAV flies) and the imaging time interval (e.g., capturing an image at every 2 second) may be determined based on the flight route, flight speed, and the aerial survey requirements. For example, the number of the aerial images acquired may not be fewer than a predetermined number and/or the overlapping rate of two adjacent images acquired may not be lower than a predetermined value.

202, transmitting the aerial photography parameter to the UAV for the UAV to acquire aerial images of the target area based on the aerial photography parameter. The aerial images can be used by the cloud server to generate the 3D model of the target area.

In the embodiments of the present disclosure, the ground station may transmit the automatically determined aerial photography parameter to the UAV, such that the UAV may acquire aerial images of the target area based on the aerial photography parameter. The aerial images can be used by the cloud server to generate the 3D model of the target area.

Details of how the UAV acquires the aerial images of the target area based on the aerial photography parameter will be described in the following embodiments, which will not be described in detail here.

Details of how the cloud server generates the 3D model of the target area based on the aerial images will be described in the following embodiments, which will not be described in detail here.

203, receiving the 3D model of the target area transmitted by the cloud server.

In some embodiments, the ground station may receive the 3D model of the entire target area transmitted by the cloud server.

In some embodiments, the ground station may receive a part of 3D model of the target area transmitted by the cloud server. More specifically, the user may select a region of interest through the display interface described above. For the convenience of description, the region of interest may be referred to as a first designated area. Those skilled in the art can understand that the first designated area may be located in the target area. Subsequently, the ground state may transmit a download request to the cloud server to acquire a 3D model of the first designated area, such that the cloud server may return the 3D model of the first designated area to the ground station based on the download request. As such, the ground station may receive the 3D model of the first designated area.

As such, it can be seen that the ground station can flexibly download the 3D models based on user operations, and the operation is convenient.

In addition, in the embodiments of the present disclosure, after the ground station receives the 3D model of the target area, the ground station may calculate 3D information of the target area based on the 3D model of the target area. The 3D information may include one or more of a surface area, a volume, a height, or a slope (e.g., degree of a slope). A person skilled in the art may refer to related description in conventional technology for the specific calculation process of the 3D information, which will not be described in detail herein.

In addition, in the embodiments of the present disclosure, after the ground station receives the 3D model of the target area, the ground station may determine a region of interest in the target area based on a user operation. For the convenience of description, the region of interest may be referred to as a second designated area. Two or more timestamps or timepoints specified by the user may be acquired and 3D models of the second designated area corresponding to the two or more timestamps may be sequentially in chronological order.

More specifically, the ground station may display the 3D model of the target area to the user through the display interface described above. The user may manually draw a selection box on the display interface of the 3D model of the target area. Then, the area corresponding to the selection box may be the second designated area.

It can be seen that through the process described above, it may be convenient for users to compare and observe changes in the same area at different time (e.g., with different timestamps). For example, the process described above may be used to show users the building process of a building in the second designated area, which may enhance the user experience.

In addition, in the embodiments of the present disclosure, after the ground station receives the 3D model of the target area, the user may specify a position of the 3D model on the display interface. For the convenience of description, the position may be referred to as a designated position. When the user specifies the designated position, one or more aerial images including the designated position (e.g., aerial images captured at the designated position and/or aerial images capturing scenes of the designated position) may be acquired and output.

Further, the user may specify a time range in advance. As such, when the user specifies the designated position, all aerial images including the designated position acquired by the imaging device carried by the UAV within the time range may be acquired, and the aerial images may be output in chronological order.

It can be seen that by using the process described above, the user experience may be improved as the user may flexibly acquire the aerial images and more fully understand the terrain and landform of the target area.

In addition, in the embodiments of the present disclosure, the ground station may be configured to handle forwarding tasks. For example, after the UAV acquires the aerial images, the aerial images may be transmitted to the ground station, and the ground station may transmit the aerial images to the cloud server, such that the cloud server may generate the 3D model of the target area based on the aerial images.

Those skilled in the art can understand that in practical applications, after the UAV acquires the aerial images, the UAV may directly transmit the aerial images to the cloud server. The forwarding through the ground station described above is an optional implementation, and the present disclosure is not limited thereto.

In addition, in the embodiments of the present disclosure, after the ground station receives the 3D model of the target area, the 3D model of the target area may be displayed to the user through the display interface described above. The user may specify a 3D flight route based on the 3D model and transmit the 3D flight route to the UAV such that the UAV may perform an autonomous obstacle avoidance flight based on the 3D flight route. Details description of a UAV's autonomous obstacle avoidance flight will be provided in the following embodiments, which will not be described in detail here.

It can be seen from the previously described embodiments that the ground station may automatically determine the aerial photography parameter for indicating the aerial photography state of the UAV based on the target area specified by the user and the map resolution, and transmit the aerial photography parameter to the UAV, such that the UAV may acquire the aerial images of the target area based on the aerial photography parameter. In this process, the ground station may automatically determine the aerial photography parameter without needing the user to have professional UAV operating skills, which may be convenient for the user to operate and provide a better user experience. Further, the ground station may also receive the 3D model of the target area generated by the cloud server based on the aerial images, which may allow users to perform various tasks such as surveying, mapping, and analysis by using the ground station, thereby meeting various operational needs of the user and improving the user experience and the portability.

Referring to FIG. 4, which is a flowchart of the 3D reconstruction method based on aerial photography of a UAV according to another embodiment of the present disclosure. On the basis of the system shown in FIG. 1, the method may be applied to the UAV 120 shown in FIG. 1. The method is described in detail below.

401, receiving the aerial photography parameter transmitted by the ground station for indicating the aerial photography state of the UAV.

Similar to the related description provided in the previous embodiments, the aerial photography parameter may include one or more of a flight route, a flight attitude, a flight speed, an imaging distance interval, or an imaging time interval.

402, flying based on the aerial photography parameter and controlling the imaging device carried by the UAV to acquire aerial images during the flight.

In the embodiments of the present disclosure, the user may operation on a control device, such as a remote control, to control the UAV to perform a one-click takeoff. As such, the UAV may take off automatically and perform the flight based on the aerial photography parameter. Those skilled in the art can understand that in the one-click takeoff process, when the UAV flies to a designated position, the UAV may automatically return to a landing position.

It can be seen that the method provided in the embodiments of the present disclosure is simple to operate, and can realize autonomous UAV flight without needing the user to have advanced UAV operating skills, which may improve the user experience.

403, transmitting the aerial images to the cloud server such that the cloud server may generate the 3D model of the target area based on the aerial images.

In some embodiments, after the UAV completes the flight operation, the UAV may transmit all of the acquired aerial images to the cloud server.

In some embodiments, the UAV may transmit the aerial images directly to the cloud server.

In some embodiments, the UAV may transmit the aerial images to the ground station, and the ground station may forward the aerial images to the cloud server.

By using this process, the ground station and the cloud server can each store a copy of the aerial images. It can be seen from the related description of the previous embodiments that the ground station may be used to display of the aerial images. As such, by using this process, the ground station may directly display the aerial images without downloading from the cloud server.

In addition, in the embodiments of the present disclosure, the UAV may also receive the 3D model of the target area generated by the cloud server from the aerial images. By using this process, the UAV may realize the autonomous obstacle avoidance flight or a terrain following flight based on the 3D model during the subsequent flight.

The process of the autonomous obstacle avoidance flight based on the 3D model will be described below.

A UAV's autonomous obstacle avoidance flight based on the 3D model may include three use cases. In the first use case, the UAV may automatically plan the flight route based on the 3D model before takeoff. In the second use case, before the UAV takes off or during flight, the predetermined flight route may be modified based on the 3D model to avoid obstacles. In the third use case, when the user is manually controlling the UAV to fly, the UAV may automatically avoid obstacles based on the 3D model, for example, the user may manually control the movement of the UAV in one dimension, and the UAV may autonomously avoid obstacles in another dimension based on the 3D model.

The process of autonomously avoiding obstacles based on the 3D model when the user manually controls the UAV to fly will be described below.

In some embodiments, the user may manually control the UAV in the horizontal direction, and the UAV may autonomously avoid obstacles in the vertical direction based on the 3D model. For example, in the application scenario where the user is manually controlling the UAV flight, the UAV may be flying based on the operation instruction issued by the user. For example, the UAV may continue to fly forward based on the user's operation instruction. However, during the flight, the UAV may encounter obstacles, such as high-rise buildings. The user may continue to transmit the forward operation instruction to the UAV regardless of the obstacles in front of the UAV's flight direction. At this time, the UAV may determine the position of the obstacle based on the 3D model in advance. Subsequently, when determining that the obstacle is located in the flight direction/route based on the user's operation instruction and the position of the obstacle, the UAV may independently control its vertical height. For example, the user's operation instruction may be performed while a rising operation may be performed at the same time to fly around a high-rise building and continue to fly forward (e.g., increase a flight altitude so that the UAV flies above the high-rise building, and decrease the flight altitude to original state after passing the high-rise building).

In some embodiments, after the UAV determines the position of the obstacle based on the 3D model, the UAV may also determine the distance between the UAV and the obstacle and the relative position between the UAV and the obstacle based on the position of the obstacle and the position of the UAV. The distance and the relative position may be transmitted to the ground station to remind the user that an obstacle may be in a certain direction and at a certain distance away from the UAV, such that the user may issue the next operation instruction based on the actual situation. As such, the UAV may not collide with the obstacle, thereby avoiding unnecessary damage caused by the collision.

The process of the UAV performing the terrain following flight based on the 3D model will be described below.

In the embodiments of the present disclosure, the user may only need to designate a plurality of waypoints considering only the horizontal direction. Those skilled in the art can understand that the waypoints may be connected to form a flight route of the UAV. For each waypoint, the UAV may determine the ground height of the waypoint based on the waypoint's position and the 3D model, and the sum of the ground height and a specified ground clearance height may be determined as the ground clearance height of the waypoint. As such, the UAV may perform the autonomous terrain following flight based on the flight route set by the user and the ground clearance height of each waypoint on the flight route.

It can be seen from the previous embodiments that by receiving the aerial photography parameter transmitted by the ground station, the UAV may perform the flight based on the aerial photography parameter, and control the imaging device to acquire aerial images during the flight. The aerial images may be transmitted to the cloud server, such that the cloud server may generate a 3D model of the target area based on the aerial images. In this process, the UAV may fly autonomously based on the aerial photography parameter and acquire aerial images independently, thereby facilitating the user operations and improving user experience. Further, the UAV may be configured to receive the 3D model transmitted by the cloud server. As such, the UAV may realize the autonomous obstacle avoidance flight and the autonomous terrain following flight.

Referring to FIG. 5, which is a flowchart of the 3D reconstruction method based on aerial photography of a UAV according to yet another embodiment of the present disclosure. On the basis of the system shown in FIG. 1, the method may be applied to the cloud server 130 shown in FIG. 1. The method is described in detail below.

501, receiving the aerial images acquired by the imaging device carried by the UAV.

In some embodiments, the cloud server may directly receive the aerial images acquired by the imaging device carried by the UAV from the UAV.

In some embodiments, the cloud server may receive the aerial images acquired by the imaging device carried by the UAV from the ground station. Of course, it can be seen form the related description previous embodiments that the ground station may also receive the aerial images from the UAV, and then forward the aerial images to the cloud server.

502, generating the 3D model of the target area based on the aerial images.

In some embodiments, after the cloud server receives the aerial images, the main server therein may divide the entire target area into multiple sub-areas based on the size of the target area and the hardware limitations of each server. The aerial images of each sub-area may be assigned to a server to realize a distributed reconstruction and improve the efficiency of the 3D reconstruction.

After each server completes the 3D reconstruction of the assigned sub-area, all of the 3D models may be integrated by one of the servers to acquire the complete 3D model of the target area.

In some embodiments, the process of the cloud server generating the 3D model of the target area based on the aerial images may include using the structure from motion (SFM) algorithm to perform the 3D reconstruction on the aerial images to acquire a 3D model of the target area. Those skilled in the art can understand that the SFM algorithm in the field of computer vision may refer to the process of acquiring three-dimensional structural information by analyzing the motion of an object. Details of performing the 3D reconstruction on the aerial images by using the SFM algorithm will not be described in detail in the present disclosure.

In some embodiments, a triangulation algorithm may be used to obtain the triangular mesh in the 3D model. More specifically, after determining the position of the imaging device, for each pixel point in each aerial image, the position of the pixel point in the 3D space may be calculated by using the triangulation algorithm based on the position of the pixel point in other aerial images, thereby recovering the dense 3D points of the entire target area. The 3D points may be filtered and fused together to form a plurality of triangles, which may be the constant data structure representing a 3D model, a triangular mesh. In some embodiments, the shape of the mesh may not be limited to a triangle, but may be other shapes, which is not limited herein.

For each triangular mesh, the triangular mesh may be projected into the corresponding aerial image by using the back projection method to acquire the projection area of the triangular mesh in the aerial image. Subsequently, texture information may be added to the triangular mesh based on the pixel values of the pixels in the projection area.

It should be noted that due to the imaging angle of the imaging device and the mutual obstruction of the scenes, some local areas may not appear in the aerial images. From the perspective of the triangular mesh, a pixel or a line may appear in the projection area of the triangular mesh, or the projection area of the triangular mesh may not appear in the aerial image. Therefore, it may be impossible to add the texture information to the triangular mesh based on the pixel values of the pixels in the projection area, and some areas may lack the texture information. As such, the visual effect may be abrupt and the user experience may be poor. Therefore, an embodiment of the present disclosure provides a method for performing texture repair on the triangular meshes missing texture information.

In one implementation of the texture repair, the triangular meshes with at least partially missing textures in the 3D model may be merged into continuous local regions based on connection relationships. For each local region on the 3D model, texture information of a textured triangular mesh and located outside the periphery of the local region (e.g., a textured triangular mesh adjacent to the peripheral edge of the local region) may be projected onto the periphery of the local region. The local region having filled its periphery with texture in the 3D plane may be projected on to a 2D plane. Then the texture information on the periphery of the local region on the 2D plane may be used as the boundary condition of the Poisson equation. The Poisson equation may be solved on the 2D image domain based on the boundary condition, and pixel values of points missing texture in the local region except the periphery may be generated, so as to fill the local region with texture. In particular, when projecting the local region in the 3D model onto the 2D plane, in one embodiment, the least square conformal transformation of the local region in the 3D model may be calculated by using a mesh parameterization algorithm, and parameterization may be performed to project the local region to a 1*1 2D plane. Further, the 1*1 projection area may be enlarged based on the area of the local region and the ground resolution to generate an n*n image. In some embodiments, n={square root over ((S/(d²)))}, where d may be the ground resolution and S may be the area of the target area. Since the filled texture is the result from solving the Poisson equation, the color inside the texture may be smooth and natural. Further, since the local regions with the missing texture use the neighboring textures outside the periphery as the boundary condition of the Poisson equation, the periphery of the local regions may connect naturally with the surrounding regions.

In some embodiments, after the cloud server generates the 3D model of the target area, the 3D model can be saved as a file in multiple formats, such as a file format for the PC platform, a file format for the Android platform, a file format for the IOS platform, etc.

By using this process, different types of ground stations may acquire the 3D model.

In addition, in the embodiments of the present disclosure, the cloud server may transmit the 3D model to the UAV, such that the UAV may perform the autonomous obstacle avoidance flight or the autonomous terrain following flight based on the 3D model. For the process of the UAV performing the autonomous obstacle avoidance flight or the autonomous terrain following flight based on the 3D model, reference may be made to the related description of the previous embodiments, and details will not be described herein again.

In addition, in the embodiments of the present disclosure, the cloud server may transmit the 3D model to the ground station, such that the ground station may perform tasks such as surveying, mapping, and analysis based on the 3D model. For the process of how the ground station works, reference may be made to the related description of the previous embodiments, and details will not be described herein again.

More specifically, the cloud server may be configured to receive a download request for acquiring the 3D model of the first designated area transmitted by the ground station. It can be seen from the related descriptions in the previous embodiments, the first designated area may be located in the target area. Subsequently, the cloud server may return the 3D model of the first designated area to the ground station based on the download request.

In addition, the cloud server may be configured to receive an acquisition request transmitted by the ground station to acquire an aerial image including a designated position. It can be seen from the related descriptions in the previous embodiments, the designated position may be located in the target area. Subsequently, the cloud server may return the aerial image including the designated position to the ground station based on the acquisition request.

It can be seen from the previous embodiments, by using the cloud server to perform the highly complex calculation work of generating the 3D model of the target area based on the aerial images, the ground station may acquire the 3D model without needing to add and maintain the expensive hardware equipment, which may be convenient for the ground station to perform operations in various scenarios.

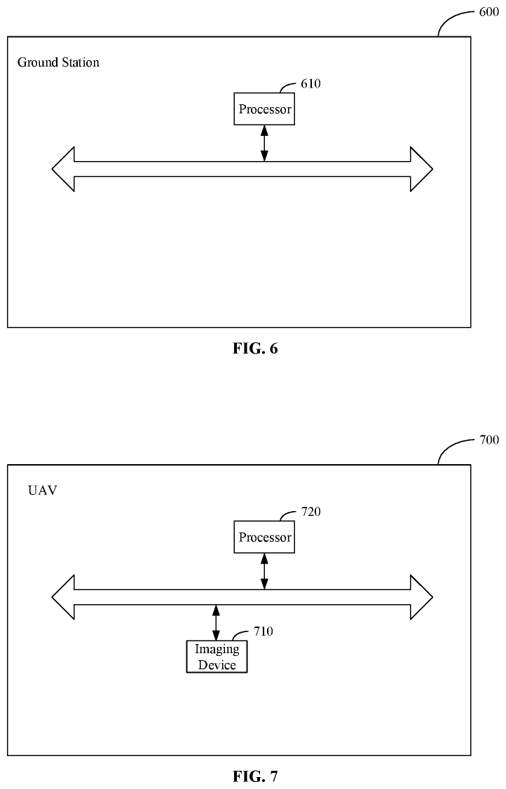

Based on the same concept of the 3D reconstruction method based on aerial photography shown in the previous embodiments of FIG. 2, an embodiment of the present disclosure further provides a ground station. As shown in FIG. 6, a ground station 600 includes a processor 610. The processor 610 may be configured to determine the aerial photography parameter for indicating the aerial photography state of the UAV based on a user operation; transmit the aerial photography parameter to the UAV for the UAV to acquire aerial images of the target area based on the aerial photography parameter, where the aerial images can be used by the cloud server to generate the 3D model of the target area; and receive the 3D model of the target area transmitted by the cloud server.

In some embodiments, the processor 610 may be further configured to receive the aerial images transmitted by the UAV; and forward the aerial images to the cloud server, such that the cloud server may generate the 3D model of the target area based on the aerial image.

In some embodiments, the processor 610 may be further configured to determine a 3D flight route established by the user based on the 3D model; and transmit the 3D flight route to the UAV for the UAV to perform the autonomous obstacle avoidance flight based on the 3D model.

In some embodiments, the processor 610 may be further configured to determine the target area specified by the user based on the user operation; acquire the amp resolution specified by the user; and determine the aerial photography parameter for indicating the aerial photography state of the UAV based on the target area and the map resolution.

In some embodiments, the aerial photography parameter may include one or more of a flight route, a flight attitude, a flight speed, an imaging distance interval, or an imaging time interval.

In some embodiments, the processor 610 may be further configured to determine a first designated area based on a user operation, the first designated area being located in the target area; transmit a download request to the cloud server to acquire a 3D model of the first designated area; and receive the a 3D model of the first designated area returned by the cloud server based on the download request.

In some embodiments, the processor 610 may be further configured to calculate the 3D information of the target area based on the 3D model of the target area.

In some embodiments, the 3D information may include one or more of a surface area, a volume, a height, or a slope.

In some embodiments, the processor 610 may be further configured to determine a second designated area based on a user operation, the second designated area being located in the target area; acquire two or more timepoints/moments specified by the user; and sequentially output the 3D models of the second designated area at the two or more specified timepoints/moments in chronological order.

In some embodiments, the processor 610 may be further configured to display the 3D model of the target area to the user through a display interface of the ground station; determine a selection box drawn by the user for the 3D model on the display interface; and determine an area corresponding to the selection box as the second designated area.

In some embodiments, the processor 610 may be further configured to determine a designated position based on a user operation on the 3D model; acquire the aerial images including the designated position; and output the aerial images including the designated position.

In some embodiments, the processor 610 may be further configured to acquire a time range specified by the user.

In some embodiments, the processor 610 may be further configured to acquire the aerial images including the designated position, which may be acquired by the imaging device within the specified time range; and sequentially output the aerial images including the designated position acquired by the imaging device within the specified time range in chronological order.

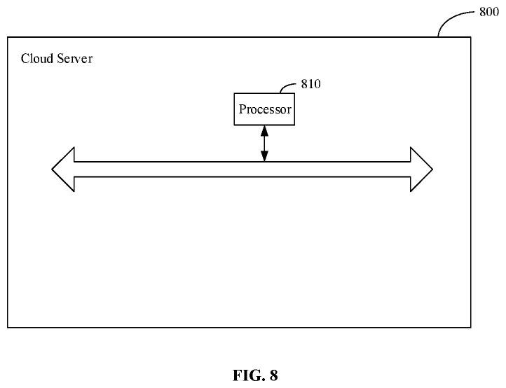

Based on the same concept of the 3D reconstruction method based on aerial photography shown in the previous embodiments of FIG. 4, an embodiment of the present disclosure further provides a UAV. As shown in FIG. 7, a UAV 700 includes an imaging device 710 and a processor 720. The processor 710 may be configured to receive the aerial photography parameter transmitted by the ground station for indicating the aerial photography state of the UAV; fly based on the aerial photography parameter and control the imaging device carried by the UAV to acquire aerial images during the flight; and transmit the aerial images to the cloud server, such that the cloud server may generate the 3D model of the target area based on the aerial images.

In some embodiments, the processor 720 may be further configured to transmit the aerial images to the ground station, such that the ground station may forward the aerial images to the cloud server.

In some embodiments, the aerial photography parameter may include one or more of a flight route, a flight attitude, a flight speed, an imaging distance interval, or an imaging time interval.

In some embodiments, the processor 720 may be further configured to control the UAV to take off based on a use operation; control the UAV to fly based on the aerial photography parameter and control the imaging device carried by the UAV to acquire aerial images during the flight; and automatically control the UAV to return to a landing position when the UAV flies to a designated position.

In some embodiments, the processor 720 may be further configured to receive the 3D model of the target area generated by the cloud server based on the aerial images.

In some embodiments, the processor 720 may be further configured to plan a flight route independently based on the 3D model to control the UAV to perform an autonomous obstacle avoidance flight.

In some embodiments, the processor 720 may be further configured to modify a predetermined flight route based on the 3D model to control the UAV to perform an autonomous obstacle avoidance flight.

In some embodiments, the processor 720 may be further configured to determine the position of the obstacle based on the 3D model; adjust the flight state of the UAV to control the UAV to perform an autonomous obstacle avoidance flight when it is determined that the obstacle is located in the flight direction based on the user operation instruction and the position of the obstacle.

In some embodiments, the processor 720 may be further configured to determine the distance between the UAV and the obstacle and the relative position between the obstacle and the UAV based on the position of the obstacle; and transmit the distance and the relative position to the ground station.

In some embodiments, the processor 720 may be further configured to determine a plurality of waypoints in the horizontal direction specified by the user; determine the ground height of the waypoint based on the 3D model for each of the waypoints; determine the sum of the ground height and the designated ground clearance as the ground clearance of the waypoint; and control the UAV to perform an autonomous terrain following flight based on the ground clearance of the waypoints.

Based on the same concept of the 3D reconstruction method based on aerial photography shown in the previous embodiments of FIG. 5, an embodiment of the present disclosure further provides a cloud server. As shown in FIG. 8, a cloud server 800 includes a processor 810. The processor 810 may be configured to receive the aerial images acquired by the imaging device carried by the UAV; and generate the 3D model of the target area based on the aerial images.

In some embodiments, the processor 810 may be further configured to receive the aerial images acquired by the imaging device carried by the UAV and transmitted by the UAV.

In some embodiments, the processor 810 may be further configured to receive the aerial images acquired by the imaging device carried by the UAV and transmitted by the ground station.

In some embodiments, the processor 810 may be further configured to acquire a 3D model of the target area by using the SFM algorithm to perform the 3D reconstruction; for the mesh on the surface of the 3D model, acquire the projection area by using the back projection method to project the mesh into the corresponding aerial images; and add texture information to the mesh based on the pixel values in the projection area.

In some embodiments, the processor 810 may be further configured to acquire the meshes with at least partially missing textures on the surface of the 3D model; merge the at least partially missing texture meshes into at least one local regions based on the connection relationship; fill the texture of the periphery of the local region based on the textures adjacent to the periphery of the local region; project the local region filled with the textures to the 2D plane. The textures of the periphery of the local region on the 2D plane may be used as the boundary condition of the Poisson equation. The Poisson equation on the 2D image domain can be solved, and the local region projected to the 2D plane may be filled with textures based on the solution of the Poisson equation.

In some embodiments, the processor 810 may be further configured to receive a download request for acquiring a 3D model of a first designated area transmitted by the ground station, the first designated area being located in the target area; and return the 3D model of the first designated area to the ground station based on the download request.

In some embodiments, the processor 810 may be further configured to receive an acquisition request transmitted by the ground station for acquiring the aerial images including a designated position, the designated position being located in the target area; and return the aerial images including the designated position to the ground station based on the acquisition request.

In some embodiments, the processor 810 may be further configured to transmit the 3D model to the UAV.

Based on the same concept of the 3D reconstruction method based on aerial photography shown in the previous embodiments of FIG. 2, an embodiment of the present disclosure further provides a machine-readable storage medium. A plurality of computer instructions may be stored on the machine-readable storage medium, and the computer instructions may be executed to determine the aerial photography parameter for indicating the aerial photography state of the UAV based on a user operation; transmit the aerial photography parameter to the UAV for the UAV to acquire aerial images of the target area based on the aerial photography parameter, where the aerial images can be used by the cloud server to generate the 3D model of the target area; and receive the 3D model of the target area transmitted by the cloud server.

In some embodiments, the computer instructions may be executed to receive the aerial images transmitted by the UAV; and forward the aerial images to the cloud server, such that the cloud server may generate the 3D model of the target area based on the aerial image.

In some embodiments, the computer instructions may be executed to determine a 3D flight route established by the user based on the 3D model; and transmit the 3D flight route to the UAV for the UAV to perform the autonomous obstacle avoidance flight based on the 3D model.

In some embodiments, in the process of determining the aerial photography parameter for indicating the aerial photography state of the UAV based on a user operation, the computer instructions may be executed to determine the target area specified by the user based on the user operation; acquire the amp resolution specified by the user; and determine the aerial photography parameter for indicating the aerial photography state of the UAV based on the target area and the map resolution.

In some embodiments, the aerial photography parameter may include one or more of a flight route, a flight attitude, a flight speed, an imaging distance interval, or an imaging time interval.

In some embodiments, in the process of receiving the 3D model of the target area transmitted by the cloud server, the computer instructions may be executed to determine a first designated area based on a user operation, the first designated area being located in the target area; transmit a download request to the cloud server to acquire a 3D model of the first designated area; and receive the a 3D model of the first designated area returned by the cloud server based on the download request.

In some embodiments, the computer instructions may be executed to calculate the 3D information of the target area based on the 3D model of the target area.

In some embodiments, the 3D information may include one or more of a surface area, a volume, a height, or a slope.

In some embodiments, the computer instructions may be executed to determine a second designated area based on a user operation, the second designated area being located in the target area; acquire two or more times specified by the user; and sequentially output the 3D models of the second designated area corresponding to the two or more specified times in chronological order.

In some embodiments, in the process of determining the second designated area based on the user operation, the computer instructions may be executed to display the 3D model of the target area to the user through a display interface of the ground station; determine a selection box drawn by the user for the 3D model on the display interface; and determine an area corresponding to the selection box as the second designated area.

In some embodiments, the computer instructions may be executed to determine a designated position based on a user operation on the 3D model; acquire the aerial images including the designated position; and output the aerial images including the designated position.

In some embodiments, the computer instructions may be executed to acquire a time range specified by the user.

In some embodiments, in the process of acquiring the aerial images including the designated position, the computer instructions may be executed to acquire the aerial images including the designated position, which may be acquired by the imaging device within the specified time range.

In some embodiments, in the process of outputting the aerial images including the designated position, the computer instructions may be executed to sequentially output the aerial images including the designated position acquired by the imaging device within the specified time range in chronological order.

Based on the same concept of the 3D reconstruction method based on aerial photography shown in the previous embodiments of FIG. 4, an embodiment of the present disclosure further provides a machine-readable storage medium. A plurality of computer instructions may be stored on the machine-readable storage medium, and the computer instructions may be executed to receive the aerial photography parameter transmitted by the ground station for indicating the aerial photography state of the UAV; fly based on the aerial photography parameter and control the imaging device carried by the UAV to acquire aerial images during the flight; and transmit the aerial images to the cloud server, such that the cloud server may generate the 3D model of the target area based on the aerial images.

In some embodiments, in the process of transmitting the aerial images to the cloud server, the computer instructions may be executed to transmit the aerial images to the ground station, such that the ground station may forward the aerial images to the cloud server.

In some embodiments, the aerial photography parameter may include one or more of a flight route, a flight attitude, a flight speed, an imaging distance interval, or an imaging time interval.

In some embodiments, in the process of flying based on the aerial photography parameter and controlling the imaging device carried by the UAV to acquire the aerial images during the flight, the computer instructions may be executed to control the UAV to take off based on a use operation; control the UAV to fly based on the aerial photography parameter and control the imaging device carried by the UAV to acquire aerial images during the flight; and automatically control the UAV to return to a landing position when the UAV flies to a designated position.

In some embodiments, the computer instructions may be executed to receive the 3D model of the target area generated by the cloud server based on the aerial images.

In some embodiments, the computer instructions may be executed to plan a flight route independently based on the 3D model to control the UAV to perform an autonomous obstacle avoidance flight.

In some embodiments, the computer instructions may be executed to modify a predetermined flight route based on the 3D model to control the UAV to perform an autonomous obstacle avoidance flight.

In some embodiments, the computer instructions may be executed to determine the position of the obstacle based on the 3D model; adjust the flight state of the UAV to control the UAV to perform an autonomous obstacle avoidance flight when it is determined that the obstacle is located in the flight direction based on the user operation instruction and the position of the obstacle.

In some embodiments, the computer instructions may be executed to determine the distance between the UAV and the obstacle and the relative position between the obstacle and the UAV based on the position of the obstacle; and transmit the distance and the relative position to the ground station.

In some embodiments, the computer instructions may be executed to determine a plurality of waypoints in the horizontal direction specified by the user; determine the ground height of the waypoint based on the 3D model for each of the waypoints; determine the sum of the ground height and the designated ground clearance as the ground clearance of the waypoint; and control the UAV to perform an autonomous terrain following flight based on the ground clearance of the waypoints.

Based on the same concept of the 3D reconstruction method based on aerial photography shown in the previous embodiments of FIG. 5, an embodiment of the present disclosure further provides a machine-readable storage medium. A plurality of computer instructions may be stored on the machine-readable storage medium, and the computer instructions may be executed to receive the aerial images acquired by the imaging device carried by the UAV; and generate the 3D model of the target area based on the aerial images.

In some embodiments, in the process of receiving the aerial images acquired by the imaging device carried by the UAV, the computer instructions may be executed to receive the aerial images acquired by the imaging device carried by the UAV and transmitted by the UAV.

In some embodiments, in the process of receiving the aerial images acquired by the imaging device carried by the UAV, the computer instructions may be executed to receive the aerial images acquired by the imaging device carried by the UAV and transmitted by the ground station.

In some embodiments, in the process of generating the 3D model of the target area based on the aerial images, the computer instructions may be executed to acquire a 3D model of the target area by using the SFM algorithm to perform the 3D reconstruction; for the mesh on the surface of the 3D model, acquire the projection area by using the back projection method to project the mesh into the corresponding aerial images; and add texture information to the mesh based on the pixel values in the projection area.

In some embodiments, the computer instructions may be executed to acquire the meshes with at least partially missing textures on the surface of the 3D model; merge the at least partially missing texture meshes into at least one local regions based on the connection relationship; fill the texture of the periphery of the local region based on the textures adjacent to the periphery of the local region; project the local region filled with the textures to the 2D plane. The textures of the periphery of the local region on the 2D plane may be used as the boundary condition of the Poisson equation. The Poisson equation on the 2D image domain can be solved, and the local region projected to the 2D plane may be filled with textures based on the solution of the Poisson equation.

In some embodiments, the computer instructions may be executed to receive a download request for acquiring a 3D model of a first designated area transmitted by the ground station, the first designated area being located in the target area; and return the 3D model of the first designated area to the ground station based on the download request.

In some embodiments, the computer instructions may be executed to receive an acquisition request transmitted by the ground station for acquiring the aerial images including a designated position, the designated position being located in the target area; and return the aerial images including the designated position to the ground station based on the acquisition request.

In some embodiments, the computer instructions may be executed to transmit the 3D model to the UAV.

Since the apparatus embodiment basically corresponds to the method embodiment, for related information, reference may be made to the description in the method embodiment. The described apparatus embodiment is merely exemplary. The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments. A person of ordinary skill in the art may understand and implement the embodiments of the present invention without creative efforts.

It should be noted that in the present disclosure, relational terms such as first and second, etc., are only used to distinguish an entity or operation from another entity or operation, and do not necessarily imply that there is an actual relationship or order between the entities or operations. The terms “comprising,” “including,” or any other variations are intended to encompass non-exclusive inclusion, such that a process, a method, an apparatus, or a device having a plurality of listed items not only includes these items, but also includes other items that are not listed, or includes items inherent in the process, method, apparatus, or device. Without further limitations, an item modified by a term “comprising a . . . ” does not exclude inclusion of another same item in the process, method, apparatus, or device that includes the item.

The method and apparatus provided in embodiments of the present disclosure have been described in detail above. In the present disclosure, particular examples are used to explain the principle and embodiments of the present disclosure, and the above description of embodiments is merely intended to facilitate understanding the methods in the embodiments of the disclosure and concept thereof; meanwhile, it is apparent to persons skilled in the art that changes can be made to the particular implementation and application scope of the present disclosure based on the concept of the embodiments of the disclosure, in view of the above, the contents of the specification shall not be considered as a limitation to the present disclosure.

What is claimed is:

1. A three-dimensional (3D) reconstruction system based on aerial photography comprising:
an unmanned aerial vehicle (UAV);
a ground station; and
a cloud server, wherein
the ground station is configured to determine an aerial photography parameter for indicating an aerial photography state of the UAV based on a user operation and transmit the aerial photography parameter to the UAV;
the UAV is configured to receive the aerial photography parameter transmitted by the ground station; fly based on the aerial photography parameter and control an imaging device carried by the UAV to acquire aerial images during a flight; and transmit the aerial images to the cloud server; and
the cloud server is configured to receive the aerial images and generate a 3D model of a target area based on the aerial images.

2. A 3D reconstruction method based on aerial photography by a UAV and applied to a ground station comprising:
determining an aerial photography parameter for indicating an aerial photography state of the UAV based on a user operation;
transmitting the aerial photography parameter to the UAV for the UAV to acquire aerial images of a target area based on the aerial photography parameter, the aerial images being used by a cloud server to generate a 3D model of the target area; and
receiving the 3D model of the target area transmitted by the cloud server.

3. The method of claim 2, further comprising:
receiving the aerial images transmitted by the UAV; and
transmitting the aerial images to the cloud server for the cloud server to generate the 3D model of the target area based on the aerial images.

4. The method of claim 2, wherein after receiving the 3D model of the target area transmitted by the cloud server further includes:
determining a 3D flight route specified by the user based on the 3D model; and
transmitting the 3D flight route to the UAV for the UAV to perform an autonomous obstacle avoidance flight based on the 3D flight route.

5. The method of claim 2, wherein determining the aerial photography parameter for indicating the aerial photography state of the UAV based on the user operation includes:
determining the target area specified by the user based on the user operation;
acquiring a map resolution specified by the user; and
determining photography parameter for indicating the aerial photography state of the UAV based on the target area and the map resolution.

6. The method of claim 2, wherein the aerial photography parameter includes one or more of a flight route, a flight attitude, a flight speed, an imaging distance interval, or an imaging time interval.

7. The method of claim 2, wherein receiving the 3D model of the target area transmitted by the cloud server includes:
determining a first designated area based on the user operation, the first designated area being located in the target area;
transmitting a download request for acquiring a 3D model of the first designated area to the cloud server; and
receiving the 3D model of the first designated area returned by the cloud server based on the download request.

8. The method of claim 2, further comprising:
calculating 3D information of the target area based on the 3D model of the target area.

9. The method of claim 8, wherein the 3D information includes one or more of a surface area, a volume, a height, or a slope.

10. The method of claim 2, after receiving the 3D model of the target area transmitted by the cloud server further includes:
determining a second designated area based on the user operation, the second designated area being located in the target area;
acquiring two or more timepoints specified by the user; and
sequentially outputting a 3D model of the second designated area based at the two or more timepoints in chronological order.

11. The method of claim 10, wherein determining the second designated area based on the user operation includes;
displaying the 3D model of the target area to the user through a display interface of the ground station;
determining a selection box drawn by the user for the 3D model on the display interface; and
determining an area corresponding to the selection box as the second designated area.

12. The method of claim 2, wherein after receiving the 3D model of the target area transmitted by the cloud server further includes:
determining a designated position based on the user operation on the 3D model;
acquiring one or more aerial images including the designated position; and
outputting the one or more aerial images including the designated position.

13. A 3D reconstruction method based on aerial photography by a UAV and applied to the UAV comprising:
receiving an aerial photography parameter transmitted by a ground station for indicating an aerial photography state of the UAV;
flying based on the aerial photography parameter and controlling an imaging device carried by the UAV to acquire aerial images during a flight; and
transmitting the aerial images to a cloud server for the cloud server to generate a 3D model of a target area based on the aerial images.

14. The method of claim 13, wherein transmitting the aerial images to the cloud server includes:
transmitting the aerial images to the ground station for the ground station to forward the aerial images to the cloud server.

15. The method of claim 13, wherein the aerial photography parameter includes one or more of a flight route, a flight attitude, a flight speed, an imaging distance interval, or an imaging time interval.

16. The method of claim 13, wherein flying based on the aerial photography parameter and controlling the imaging device carried by the UAV to acquire aerial images during the flight includes:
controlling the UAV to take off based on a user operation;
controlling the UVA to fly based on the aerial photography parameter and controlling the imaging device carried by the UAV to acquire the aerial images during the flight; and
automatically controlling the UAV to return to a landing position when the UAV flies to a designated position.

17. The method of claim 13, further comprising:
receiving the 3D model of the target area generated by the cloud server based on the aerial images.

18. The method of claim 17, after receiving the 3D model of the target area generated by the cloud server based on the aerial images further includes:
independently planning a flight route based on the 3D model for the UAV to perform an autonomous obstacle avoidance flight.

19. The method of claim 17, after receiving the 3D model of the target area generated by the cloud server based on the aerial images further includes:
modifying a predetermine flight route based on the 3D model to control the UAV to perform the autonomous obstacle avoidance flight.

20. The method of claim 17, after receiving the 3D model of the target area generated by the cloud server based on the aerial images further includes:
determining a position of an obstacle based on the 3D model; and
adjusting a flight state of the UAV to control the UAV to perform the autonomous obstacle avoidance flight in response to determining the obstacle being located in a flight direction based on a user operation instruction and the position of the obstacle.
